(19) United States
(12) Patent Application Publication
(10) Pub. No.: US 2015/0081541 A1
(43) Pub. Date: Mar. 19, 2015

(54) METHOD AND SYSTEM FOR ENABLING TRANSACTION CARD SECURITY

(71) Applicant: Dorothy A. Hogg, South Nyack, NY (US)

(72) Inventor: Russell Elton Hogg, South Nyack, NY (US)

(21) Appl. No.: 14/009,001

(22) PCT Filed: Mar. 30, 2012
(86) PCT No.: PCT/US12/31450

§ 371 Date: Oct. 2, 2014

Related U.S. Application Data
(60) Provisional application No. 61/470,955, filed on Apr. 1, 2011.

(51) Int. Cl. G06Q 20/40; H04L 29/08

(52) U.S. Cl. CPC G06Q 20/4016; H04L 67/10
USPC 705/44

(57) ABSTRACT

Herein is disclosed a method of preventing a fraudulent payment transaction conducted via a payment network that includes a point of sale system and an issuer system. The method includes intercepting an authorization request as the authorization request traverses the payment network from the point of sale system to the issuer system. Next, it is determined whether a security method is associated with an account number associated with the authorization request. In the event that it is determined that there is a security method associated with the authorization request, the associated security method is applied. The authorization request is retransmitted through the payment network to the issuer system.

This application is being filed on 30 Mar. 2012, as a PCT International Patent application in the name of Russell Elton Hogg, a citizen of the U.S., applicant for the designation of all countries, and claims priority to U.S. Patent Application Ser. No. 61/470,955 filed on 01 Apr. 2011, the disclosure of which is incorporated herein by reference in its entirety.

### FIELD OF THE INVENTION

The present document related generally to a computerized system and method for the prevention of payment card fraud, and more particularly to a system and method that may be deployed in the context of a traditional payment network environment.

### BACKGROUND

Credit and debit card fraud is prevalent throughout the world, despite existing fraud detection and prevention methods. In the United States alone, it is estimated that between three and four billion dollars in credit card occurs annually. These losses are borne primarily by either the financial institutions that issued the payment cards through which the fraud transactions were committed, although the costs are also borne by the consumers, themselves. In the United States, the liability for these sorts of losses is governed by federal law and regulations.

Most fraud prevention techniques rely upon heuristic and statistical analysis of both legitimate individual consumer behavioral patterns and fraudulent behavioral patterns. In other words, traditional schemes function either by characterizing “normal” spending patterns exhibited by a particular consumer, and disabling a card in the wake of a transaction falling outside the norm, or by characterizing transactions that are fraudulent, and determining that a particular transaction falls within the boundaries determined to be general fraudulent. In either event, a cardholder is typically contacted via telephone call in the wake of having identified a suspicious transaction, meaning that if the transaction is determined to have, indeed, been fraudulent, at least one loss is incurred prior to disabling the consumer's card. Moreover, it is important to note that neither characterization of legitimate spending behavior, nor characterization of fraudulent spending behavior, can be perfectly achieved—an unfortunate reality leaving the payment card industry in a state of affairs wherein fraud simply remains a cost of doing business.

There continues to exist a need for suppressing fraudulent payment card transactions, preferably prior to the occurrence of such transactions.

### SUMMARY

Against this backdrop, the present invention was formed. One embodiment of the invention is a method of preventing a fraudulent payment transaction conducted via a payment network that includes a point of sale system and an issuer system. The method includes intercepting an authorization request as the authorization request traverses the payment network from the point of sale system to the issuer system. Next, it is determined whether a security method is associated with an account number associated with the authorization request. In the event that it is determined that there is a security method associated with the authorization request, the associated security method is applied. The authorization request is retransmitted through the payment network to the issuer system.

### BRIEF DESCRIPTION OF THE DRAWINGS

FIG. 1 depicts an example of a payment network with an example of an embodiment of a security system introduced into the network.

FIG. 2 depicts an example of an embodiment of a security election system that may be used in connection with the security system.

FIG. 3 depicts an example of an embodiment of a method that may be implemented in execution flow by the security system.

### DETAILED DESCRIPTION

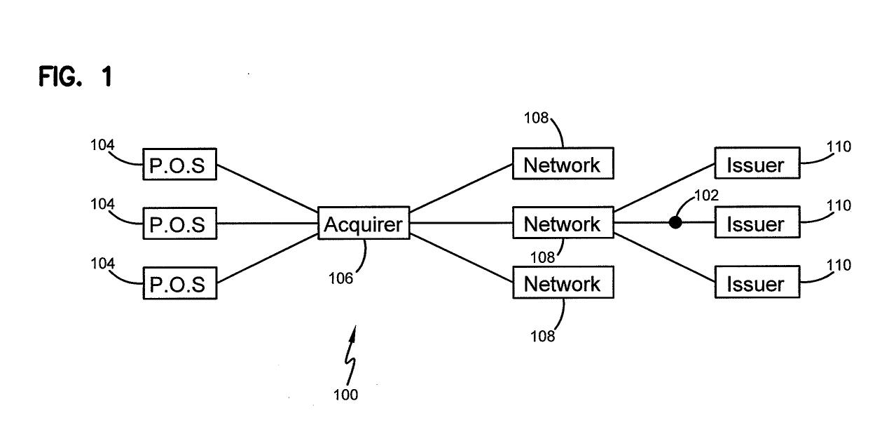

FIG. 1 depicts a payment network 100 with certain exemplary embodiments of a security system 102 introduced therein. The payment network 100 includes one or more points of sale 104, which may be in the form of cash registers at traditional bricks and mortar merchant locations, card “swipe” devices, also located at traditional bricks and mortar merchant locations, on-line shopping carts, operated by e-commerce sites, etc. A transaction originates at a point of sale 104, where an authorization request (a request to authorize a charge to a particular account, for a specified sum of money, at a particular merchant location, and at a particular time and date) is transmitted to an acquirer system 106.

The acquirer system 106 parses the authorization request to determine the identity of the particular issuer network system 108 (examples: American Express, Visa, MasterCard, Discover, PayPal, etc.) to which the authorization request should be transmitted. The authorization request is received by the issuer network system 108, which again parses the request to determine the particular issuer 110 system to which the authorization should be transmitted. Upon receipt by the appropriate issuer system 110, known as an authorization system, authorization engine or system of record, the authorization request is processed to determine whether the particular account that is the subject of the authorization request has a sufficient balance or sufficient line of available credit to honor the transaction, to determine whether the account has been suspended, etc. Thus, in whole, the payment network 100 is constituted of switching elements to progressively switch the authorization request to the appropriate issuer system 110, whereupon the authorization request is processed to determine whether the request should be replied to with an authorization or declination. Upon authorization or declination, a response containing the authorization or declination is transmitted back through the payment network 100, retracing its original route in reverse order.

As can be seen from FIG. 1, a security system 102 is introduced into the payment network 100. According to the embodiment depicted in FIG. 1, the security system 102 is interposed between the network system 108 and issuer system 102, although, the security system may be interposed between the acquirer system 106 an network system 108, or may be interposed between the point of sale 104 and acquirer system 106. According to one embodiment, the security system 102 functions as an eavesdropper introduced into the payment network 100 as described above. The system 102 awaits authorization requests, and upon receiving such a request, the system 102 determines whether a security method is associated with the account to which the authorization request is directed. If no security method is associated with the account, then the authorization request is permitted to pass on its way so that it is ultimately received by the issuer system 110, and the response to the request is also permitted to pass, so that the response is ultimately received by the appropriate point of sale 104 and the transaction can be completed. On the other hand, if a security method is associated with the account that is the subject of the authorization request, then the security system 102 invokes the method, and the authorization/declination response corresponding to the authorization requested is intercepted, and will not be passed on to the point of sale 104 until the security method has been completed and a response indicating that the transaction is legitimate has been received. If such a response is received, then the authorization/declination response is released and transmitted through the payment network 100 to the appropriate point of sale 104. In contrast, if upon invocation of the security method, the security method returns a response indicating that the transaction cannot be verified as legitimate, then the a declination response is returned through the payment network 100, so that an authorization request will not be mated to an authorization unless the security method indicates that the transaction is legitimate.

By way of example only, the security method may include the following actions. Upon invocation, the security method causes a message to be communicated to a mobile device, such as a smart cell phone, known to be used by the cardholder associated with the account that is the subject of the authorization request. The message causes the mobile device to prompt its user to respond by either authorizing or declining the transaction. According to one embodiment, the authorization or declination message must be accompanied by a PIN associated with the account that is the subject of the authorization request. Thus, in use, the security system 102 causes a sale transaction to proceed as follows: a cardholder uses his card (or card number, in the case of a card-not-present transaction, or in the case of an on-line transaction) at a point of sale 104, causing an authorization request to be communicated through the payment network to an issuer system 110; the authorization request is received by the security system 102; the security system determines whether a security method is associated with the account that is the subject of the authorization request, and if so, invokes the security method; the authorization request is permitted to continue along its route to the issuer system 110; invocation of the security method causes a message to be communicated to a mobile device, such as a cellular telephone, associated with the holder of the account; the message is received by the mobile device, which invokes a unit of software resident on the device, and the mobile device responds by prompting the user of the device with the amount of the proposed transaction, location of the proposed transaction, and/or the time/date of the proposed transaction, and instructing the user of the device to either authorize or decline the transaction; the user authorizes or declines the transaction, and enters a PIN; the information is communicated to the security system 102; the security system 102 authenticates the PIN, and if the PIN is authenticated, determines whether the user authorized or declined the transaction; in the event that the authorization request is declined by the user, then the security system responds to the authorization request with a declination response on behalf of the issuer system 110; in the event that the user authorizes the transaction, the authorization/declination response from the issuer system 110 is permitted to pass along its route to the point of sale 104 (the authorization/declination response is intercepted and held at the security system 102 until such time as the user authorizes or declines the proposed transaction).

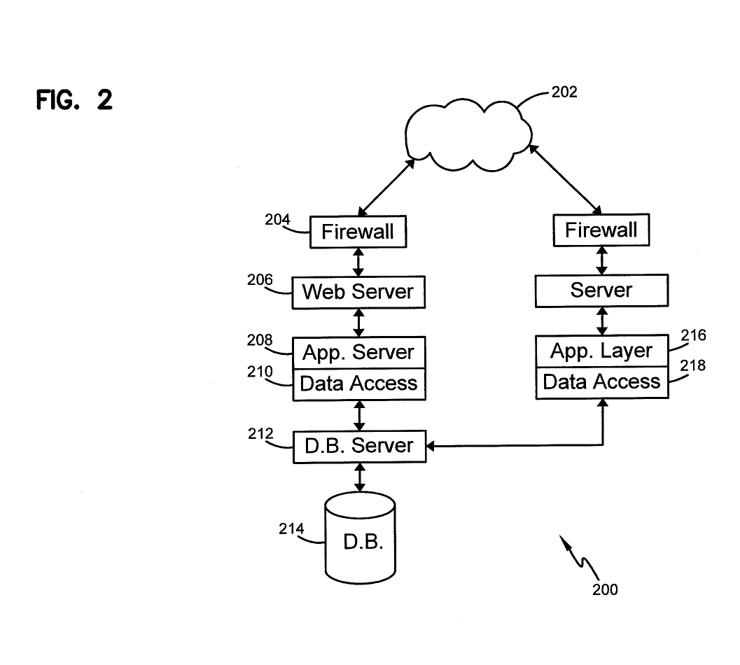

According to one embodiment, the security system 102 of FIG. 1 may be used in conjunction with the security election system 200 of FIG. 2. The security election system 200 delivers a website by which a cardholder may enter his card number and elect to enable a security method in association with his card number. The cardholder may also elect to set certain parameters associated with any enabled security method, as discussed below.

As can be seen from FIG. 2, the security election system 200 may be accessed via an open network, such as the Internet 202. According to some embodiments, the front end of the security election system may include a firewall 204, which may be configured to provide security functions, such as filtering out IP packets addressed to a port other than the particular port assigned to the web server (typically port 80) and performing other well known security functions. The firewall 204 passes appropriate Internet traffic to the web server 206, which parses an incoming HTTP request, and passes the request to the application server 208. The application server 208 cooperates with the data access layer 210, database server 212 and database 214 to present web pages that permit a user to elect to associate a security method with his payment card number. For example, a user may access the web site presented by the security election system 200, and in response to accessing the system 200, the system 200 presents a web site that permits the user to elect to have a message sent to his mobile device, which message prompts the mobile device to prompt the user to authorize or decline a particular transaction, as an essential step of the authorization process. The security election system 200 may present other security methods for election by a user, as well. For example, the security election system 200 may provide the option for the user to elect to have his payment account inactive, unless explicitly activated. During periods of inactivity, authorization requests are declined. On the other hand, during periods of activity, authorization requests are responded to in the ordinary course, i.e., they are authorized or declined based upon the normal operation of the issuer system 110. The user may access an application resident on his mobile device to activate his account. For example, the user may access an application, enter a PIN number (or password) associated with his payment account, and elect to activate his account for a specified duration, such as for the next hour, or may specify a start time/date and end time/date during which the account is to be activated.

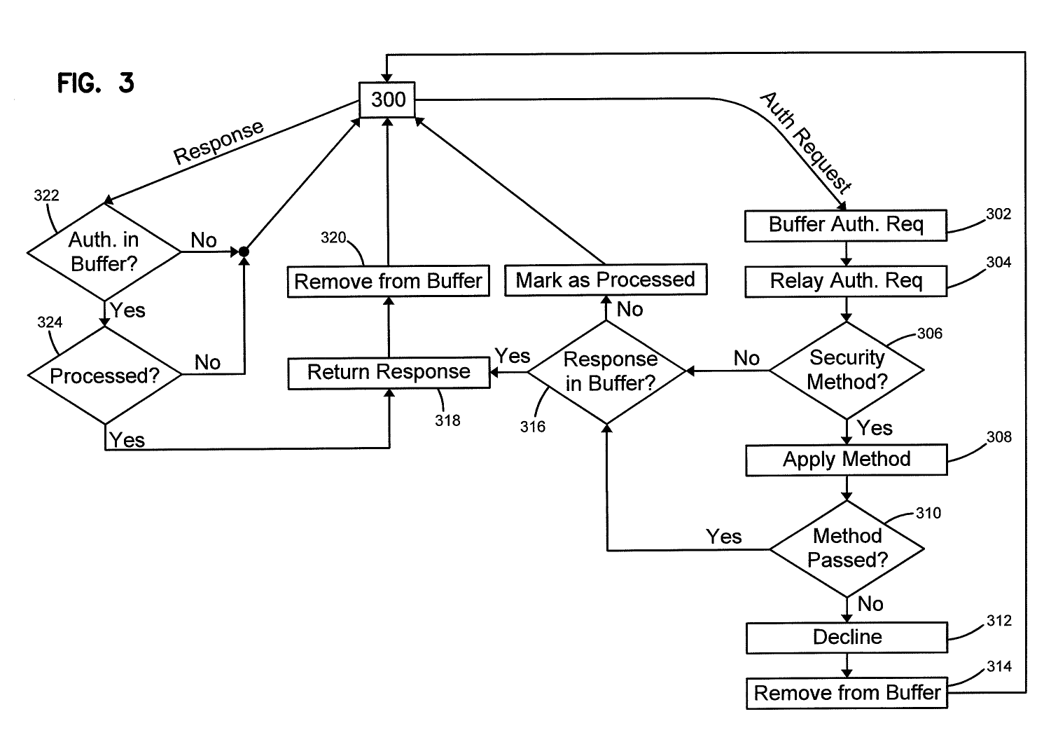

FIG. 3 depicts an example of an embodiment of steps comprising the software of the security system. One skilled in the art understands that the security system 102 undertakes steps that may be executed by software executed on an appropriate computing platform, by hardware, such as one or more ASICs, or by a combination of hardware and software. As shown in FIG. 3, the security system 102 begins in a waiting state 300. During this state, the security system 102 is monitoring its network interface, awaiting the reception of an authorization request from a point of sale 104 or a response to an authorization request from an issuer system 110. In the event that an authorization request is received, the security system 102 buffers the authorization request, as shown in operation 302, and then, in operation 304, retransmits that authorization request through the payment network 100 to the issuer system 110. Next, in operation 306, the security system 302 determines whether or not a security method is associated with the account number that is the subject of the authorization request. According to one embodiment, the security system 102 communicates with the security election system 200 to make this determination. For example, the security system 102 may transmit a message to a separate application layer 216 of the security election system 200. This particular application layer 216 receives the message with the account number in question embedded therein, and queries the database 214 via the cooperative efforts of the data access layer 218 and the database server 212 to determine the security method associated with the account number. The application layer 216 responds to the security system 102, identifying the particular security method, if any, associated with the account number.

In the event that a security method is associated with the account number, then the security system 102 applies the particular security method, as depicted in operation 308. For example, if an authorization request is received during a period in which the account is inactive, then application of the security method results in returning a value that indicates that the security method was not passed, i.e., the application of the security method shows that the transaction is not to be considered authentic. If the authorization request is received during a period in which the account is active, then application of the security method results in returning a value that indicates that the security method was indeed passed, i.e., the application of the security method shows that the transaction is to be considered authentic. Similarly, if the security method associated with the account indicates that a message is to be sent to the mobile device of the user, then the security system 102 applies the method, i.e., it originates the communication of a message to the mobile device, in order to cause software resident on the device to prompt the user with a message asking whether the proposed transaction is to be authorized. If the user authorizes the proposed transaction and enters the correct PIN/password, then the application of the security method results in returning a value that indicates that the security method was indeed passed, i.e., the application of the security method shows that the transaction is to be considered authentic. Otherwise, application of the security method results in returning a value that indicates that the security method was not passed, i.e., the application of the security method shows that the transaction is not to be considered authentic. In operation 310, application of the security method is tested, to determine whether or not the security method was passed, i.e., whether or not the proposed transaction is to be considered authentic. If the security method is not passed, then the proposed transaction is not to be considered authentic, and the security system 102 transmits a declination response through the payment network 100 to the point of sale 104 from which the authorization request originated, as shown in operation 312. Thereafter, the authorization request is removed from the buffer (operation 314), and the security system 102 returns to its original state 300. Returning attention to operation 310, if the security method is passed, then the proposed transaction is considered authentic, and the security system 102 passes control to operation 316 wherein the security system tests to see whether the response (from the issuer system 110) corresponding to the authorization request is stored in the buffer in association with the authorization request. If the response is stored in the buffer, then the response is transmitted through the payment network 100 to the point of sale 104 from which the authorization request emanated (operation 318), the authorization request and corresponding response are removed from the buffer (operation 320), and control is returned to the original state 300. If the response is not stored in the buffer, this indicates that the issuer system 110 has not yet responded with an authorization or declination. In this case, the security system 102 marks the authorization request as processed, as shown in operation 322, and returns control to the original state 300.

Returning attention to original state 300, in the event that a response from an issuer system 110 is received by the security system 102, then control is passed to operation 322, wherein the security system 102 tests to determine whether the authorization request corresponding to the response is remaining in the buffer. If it is no longer remaining in the buffer, then control is returned to the original state 300. On the other hand, if the corresponding authorization remains in the buffer, control is passed to operation 324 to test to determine whether the authorization request is marked as processed, which, in turn, indicates that no security method was associated with the account number associated with the authorization request, or that the associated security method has already been applied. If the authorization request is not marked as processed, then control is returned to operation 300. Alternatively, if the authorization request is marked as processed, then control is passed to operation 318, and execution flow proceeds as previously described in connection with operation 318.

The various embodiments described above are provided by way of illustration only and should not be construed to limit the invention. Those skilled in the art will readily recognize various modifications and changes that may be made to the present invention without following the exemplary embodiments and applications illustrated and described herein, and without departing from the true spirit and scope of the present invention, which is set forth in the various claims.

The claimed invention is:

1. A method of preventing a fraudulent payment transaction conducted via a payment network comprising point of sale system and issuer system, the method comprising:
intercepting an authorization request as the authorization request traverses the payment network from the point of sale system to the issuer system;
determining whether a security method is associated with an account number associated with the authorization request;
in the event that it is determined that there is a security method associated with the authorization request, applying the associated security method.
retransmitting the authorization request through the payment network to the issuer system.
